(19) United States
(12) Patent Application Publication
(10) Pub. No.: US 2006/0217960 A1
(43) Pub. Date: Sep. 28, 2006

(54) Translation device, translation method, and storage medium

(75) Inventors: Masahiro Kato, Ashigarakami-gun (JP); Masanori Onda, Ashigarakami-gun (JP); Katsuhiko Itonori, Ashigarakami-gun (JP); Hideaki Ashikaga, Ashigarakami-gun (JP); Shunichi Kimura, Ashigarakami-gun (JP); Masanori Satake, Ebina-shi (JP); Hiroki Yoshimura, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/221,800

(22) Filed: Sep. 9, 2005

(30) Foreign Application Priority Data
Mar. 25, 2005 (JP) 2005-090233

(51) Int. Cl. G06F 17/28

(52) U.S. Cl. 704/2

(57) ABSTRACT

A translating device has: an input unit that inputs a document; a unit that specifies a target language; a unit that translates the inputted document into the translated document written in the target language; a memory that stores a set of condition data and advertisement data assigned to the condition data, or a set of a keyword and advertisement data assigned to the keyword; a unit that selects advertisement data from the memory, the advertisement data being assigned either to condition data or a keyword; a unit that determines an insertion location at which to insert the advertisement data selected by the data selection unit into the translated document, by taking into account a layout of the translated document; a unit that generates an output image of the translated document by inserting the advertisement data at the insertion location; and a unit that outputs the output image.

### BACKGROUND OF THE INVENTION

1. Field of the Invention

The present invention relates to a method, a device and a storage medium for translation of a document from one language to another language.

2. Description of the Related Art

Various approaches have been proposed for using different types of printing media to advertise widely to consumers, so as to promote sales of goods, or to improve a corporate brand image.

For example, it is known to provide a photocopier and a scheme for discounting a photocopying charge. The photocopier identifies a key word in a document, and prints an advertisement relating to the recognized keyword in a margin or on the back of a paper, while photocopying the document onto the front of the paper. When an advertisement is printed in this way, the photocopying charge is discounted by an amount covered by an individual or a corporation (hereinafter referred to collectively as a sponsor) sponsoring the advertisement.

A similar approach may be applied to a translation device which is adapted to translate a document from one language to another language; for example, from Japanese to English, French, or Chinese.

However, problems arise when such a translation device is used; for example, in a case that a native speaker of English who is not able to understand a Japanese document translates a Japanese document into English using the translation device. According to the above related art, s/he will obtain an English translation of a document including an advertisement written in Japanese. In such a situation, the advertisement is not effective, since s/he may not understand the advertisement written in Japanese.

Additionally, a foreign resident outside Japan may obtain an English translation of a Japanese document including an advertisement for goods which are available only in Japan. In this situation also, the advertisement is not effective.

Thus, there is little incentive for a sponsor to provide advertisements aimed at users of such translation devices.

### SUMMARY OF THE INVENTION

The present invention has been made in view of the above circumstances and provides a translation device including: an input unit that inputs a document; a specifying unit that specifies a target language; a translation unit that translates the inputted document into the translated document written in the target language specified by the specifying unit; a memory that stores a set of condition data and advertisement data assigned to the condition data, or a set of a keyword and advertisement data assigned to the keyword; a data selection unit that selects advertisement data from the memory, the advertisement data being assigned either to condition data or a keyword; a location determining unit that determines an insertion location at which to insert the advertisement data selected by the data selection unit into the translated document, by taking into account a layout of the translated document; a image generating unit that generates an output image of the translated document by inserting the advertisement data at the insertion location determined by the location determining unit; and an outputting unit that outputs the output image generated by the image generating unit.

### BRIEF DESCRIPTION OF THE DRAWINGS

Embodiments of the present invention will be described in detail based on the following figures, wherein:

FIG. 1 illustrates a functional block diagram of translation device 1 according to the first embodiment;

FIGS. 2 to 4 illustrate operational flows of translation device 1 according to the first embodiment;

FIG. 5 illustrates examples of data flows at translation device 1 for different target languages according to the first embodiments;

FIG. 6 illustrates a functional block diagram of translation device 1 according to the second embodiment;

FIGS. 7 and 8 illustrate operational flows of translation device 1 according to the second embodiment;

FIG. 9 illustrates an example of an advertisement charge table according to the second embodiment;

FIGS. 10 and 11 illustrate operational flows of translation device 1 according to the second embodiment;

FIG. 12A illustrates an example of an image of a translation of a document;

FIG. 12B illustrates an example of an output image of a translation of a document including an advertisement;

FIG. 12C illustrates an example of an advertisement report, in which some terms are masked by shading; and

FIG. 13 illustrates a hardware configuration of translation device 1.

### DETAILED DESCRIPTION OF THE INVENTIONS

### A. First Embodiment

A-1. Configuration

Translation device 1 is adapted to translate a document to a target language, and to generate a copy of the translated document.

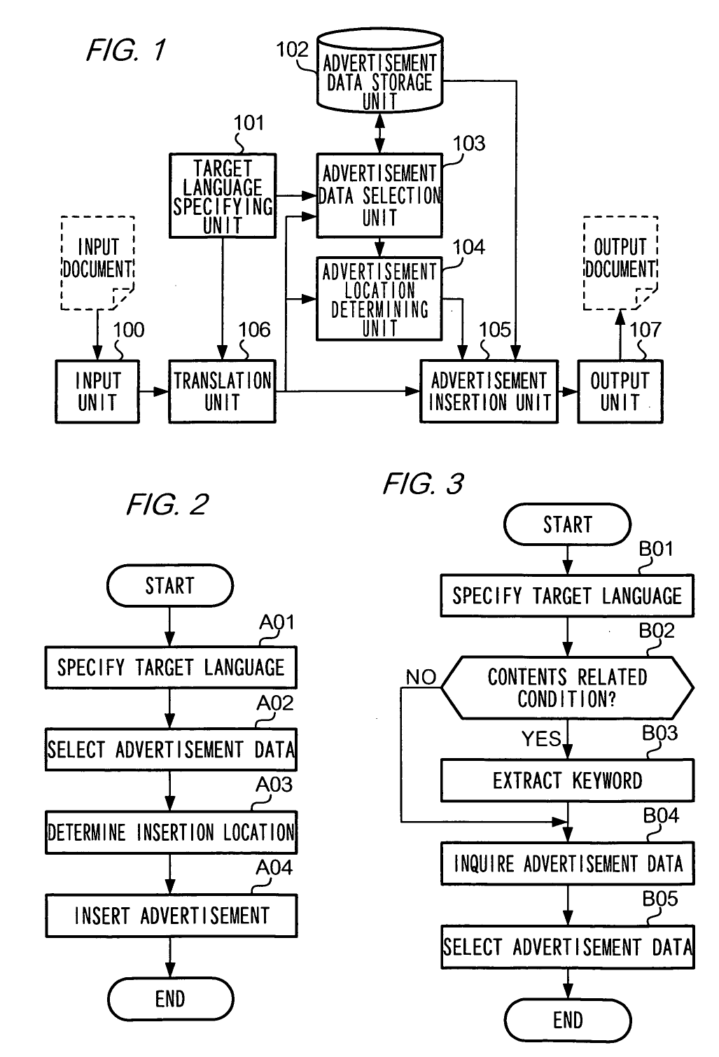

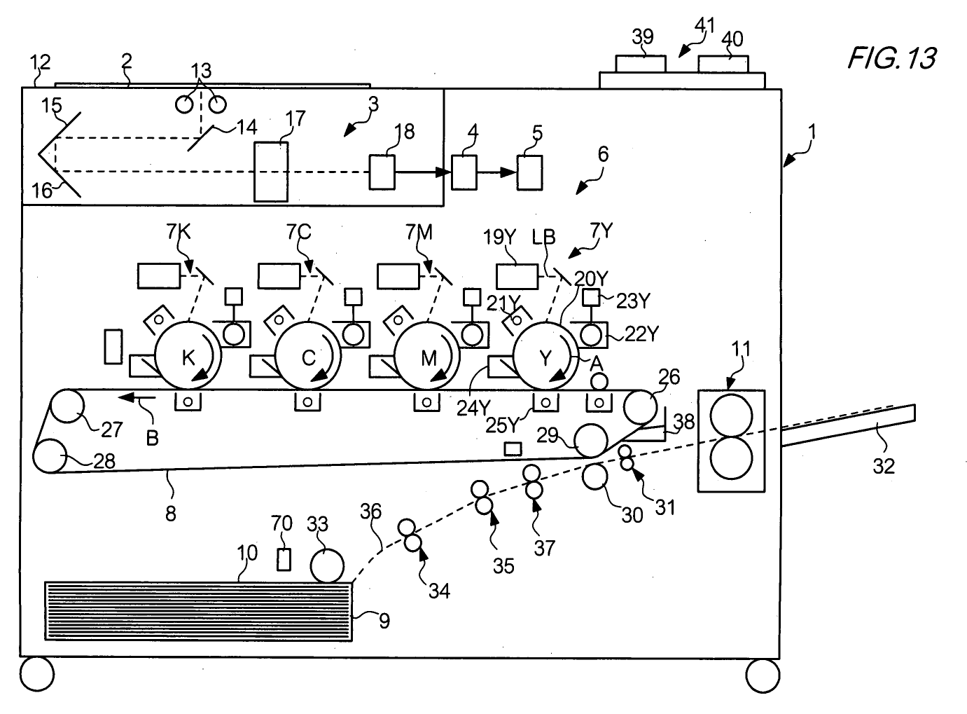

FIG. 13 illustrates a hardware configuration of translation device 1. Translation device 1 has a control unit 4. Control unit 4 includes a CPU (Central Processing Unit), a ROM (Read Only Memory), and a RAM (Random Access Memory), which are not shown in FIG. 1. CPU executes OS (Operating System) programs stored in ROM to control components of translation device 1.

Storage unit 5 is non-volatile, and is configured as a hard disk drive unit or the like. Storage unit 5 stores dictionary 51 including a set of words and their corresponding meanings in multiple languages. Storage unit 5 also stores computer programs for performing operations, such as inputting, translating, and outputting a document.

Instruction input unit 41 has a keyboard 40 with a ten keypad and a start button, and has a display unit 39 including an LCD panel with a touch panel function. A user may input instructions to translation device 1 via instruction input unit 41. In case of malfunctions of translation device 1, status of translation device 1 may be displayed at display unit 39.

Sheets 10 adapted to have images formed thereon are stacked on paper feed tray 9. When an instruction to form images on a sheet 10 is input via instruction input unit 41, paper feed roller 33 starts rotating, and feeds sheets 10 one-by-one from paper feed tray 9. Sheets 10 are conveyed along conveyance path 36 by means of paired rollers 34, 35, 37.

Image input unit 12 inputs a document optically, and generates image data.

Image input unit 12 may be configured as a scanning unit. More specifically, light is radiated from light source 13 onto a document put on platen glass 2. Light from the document is reflected via mirrors 14, 15, 16 and received by light reception unit 17. Image processing unit 18 converts the reflected light received by light reception unit 17 to electric signals, so as to generate image data consisting of colors of Yellow (Y), Magenta (M), Cyan (C), and Black (K).

Image forming unit 6 has image forming mechanisms 7Y, 7M, 7C, 7K, and a transferring belt 8.

Image forming mechanisms 7Y, 7M, 7C, 7K each form toner images of a single color of Yellow, Magenta, Cyan, and Black, respectively. Since these image forming mechanisms have identical configurations, only the details of image forming mechanism 7Y will be described.

Image forming mechanism 7Y includes a photoconductive drum 20Y (image support member), on which electro-static latent image is formed, and by which toner image is supported. Image forming mechanism 7Y also includes an electro-static charging unit 21Y, an exposure unit 19Y, a development unit 22Y, and a cleaning unit 24Y around photoconductive drum 20Y.

Electro-static charging unit 21Y uniformly charges the whole surface of photoconductive drum 20Y to a certain electric potential level of a uniform polarity, while photoconductive drum 20Y is rotating in a direction of arrow A.

Exposure unit 19Y radiates a beam of light on the surface of photoconductive drum 20Y in accordance with image data.

Exposure unit 19Y may be configured as a Raster Output Scanner.

More specifically, exposure unit 19Y scans a laser beam emitted from a semiconductor laser unit (not shown) in accordance with image data, so as to form an electro-static latent image on the surface of photoconductive drum 20Y. After the laser beam is radiated on an area of the surface of photoconductive drum 20Y, the electric potential level of the area reduces in accordance with the intensity of the laser beam due to photoconductivity of photoconductive drum 20Y. Thus, an electro-static latent image corresponding to the image data is formed on the surface of photoconductive drum 20Y.

Development unit 22Y develops the electrostatic latent image formed on the surface of photoconductive drum 20Y. More specifically, toner (electrostatically charged color pigmental material) is charged with the same polarity as the surface of photoconductive drum 20Y. Then, toner is fed from toner tank 23Y to the surface of photoconductive drum 20Y, so as to generate a toner image on the surface of photoconductive drum 20Y. Thus a toner image, which is a negative image of the electrostatic latent image, is formed on the surface of photoconductive drum 20Y.

Transferring belt 8 is hung on rollers 26, 27, 28, 29, and is driven rotatingly in the direction of arrow B. Transferring belt 8 runs below photoconductive drum 20Y. When photoconductive drum 20Y is pressed against transferring belt 8, the toner image formed on the photoconductive drum 20Y is transferred to transferring belt 8.

Cleaning unit 24Y removes residual toner from photoconductive drum 20Y.

Similarly, in image forming mechanisms 7M, 7C, 7K, a toner image of each color is formed on photoconductive drum 20M, 20C, 20K, respectively. The toner image of each color is overlappingly transferred to transferring belt 8, successively.

Where it is not necessary to distinguish between image forming mechanisms 7Y, 7M, 7C, 7K, they are simply collectively referred to as image forming mechanism 7. Similarly, where it is not necessary to distinguish between colors for other components, the notations Y, M, C, K will also be omitted.

After sheet 10 is fed from paper feed tray 9 on conveyance path 36, sheet 10 enters the nip portion formed between transferring belt 8 and transfer roller 30, and is pressed against transferring belt 8. The pressing force and electro-static suction force from sheet 10 causes the toner image to be transferred onto the surface of sheet 10.

After that, sheet 10 is guided into fusing unit 11 by paired roller 31, and fusing unit 11 presses and heats sheet 10 so that the toner is fused on the surface of sheet 10. Thus, an image is formed on sheet 10, and sheet 10 is ejected out to catch tray 32.

A-2. Functions

FIG. 1 illustrates a functional block diagram of translation device 1. CPU executes programs stored in storage unit 5 to perform these functions.

Input unit 100 inputs a document by using image input unit 12, and generates image data of the document.

Storage unit 5 stores a known OCR (Optical Character Recognition) program. CPU executes the OCR program and performs character recognition.

A target language for translation is specified by target language specifying unit 101. More specifically, a menu listing names of various target languages is displayed at display unit 39. A target language is specified by a user via a touch panel function provided in displaying unit 39.

Translation unit 106 generates, from the image data of a document generated by input unit 100, a translation of the document written in the language specified by target language specifying unit 101. For example, a known morphological analysis approach, a known syntax analysis approach, and a known semantic analysis approach may be applied to generate a translation of a document by analyzing syntaxes of the document to generate syntax trees of the document, converting the syntax trees to a target language, selecting a translation of each morpheme from dictionary 51, and replacing each morpheme with its translation in the converted syntax trees.

Advertisement data storage unit 102 stores a set of a condition data and advertisement data assigned to the condition data, or stores a set of a keyword and advertisement data assigned to the keyword. In the present example, advertisement data storage unit 102 has a non-volatile memory, and is connected to translation device 1 via a network.

Advertisement data selection unit 103 selects from advertisement data storage unit 102 advertisement data assigned either to condition data, being data of generating a translation of a document at translation unit 106, or to a keyword included in a document to be translated with translation unit 106.

In the first example, condition data includes a condition relating to a target language. Advertisement data storage unit 102 stores advertisement data prepared for each target language. More specifically, advertisement data storage unit 102 stores advertisement data written in a number of languages for several models of car. Advertisement data selection unit 103 selects, from advertisement data storage unit 102, the advertisement data assigned to condition data relating to the target language specified by target language specifying unit 101.

In the second example, condition data includes a condition relating to an exporting country. Advertisement data storage unit 102 stores advertisement data referring to specifications of a product, such as a car, specified depending on a country importing the product. Advertisement data storage unit 102 stores advertisement data of motorcycles for some importing countries, where many motorcycles are sold and a small number of cars are sold. Accordingly, advertisement data, suitable for an importing country of a product, may be selected from advertisement data storage device 102.

In the third example, condition data includes a keyword of a document; the keyword expressing contents of the document concisely.

For example, condition data may include terms frequently appearing in a document as keywords of the document. If technical terms relating to a car appear frequently in a document, an advertisement relating to cars is determined to be most suitable for the document, since the reader of the document is likely to be interested in cars and related technologies.

As is described above, advertisement data storage unit 102 stores a set of a keyword and advertisement data assigned to the keyword. Accordingly, advertisement data suitable for a document may be selected.

Advertisement location determining unit 104 determines, by taking into account the layout of the translation of the document translated by translation unit 106, an insertion location of an advertisement image in an output image corresponding to the advertisement data selected by advertisement data selection unit 103. More specifically, advertisement location determining unit 104 analyzes the image data generated by input unit 100, and stores in storage unit 5 layout information of the document and typeface information used in the document. In translating to a target language, CPU generates an output image of a translation of a document by using an identical layout and identical type faces (if any) to those used in the document to be translated. However, in translating an English document and generating a Japanese document in which the text appears vertically, CPU generates an output image of the Japanese translation in a layout determined by a prescribed rule, for example by using identical character spacing and identical line spacing to a document to be translated and using Mincho typeface as a default type face.

CPU determines whether there remains space for inserting the advertisement in the output image of the translation thus generated.

If there does not remain enough room for the advertisement, CPU detects a first part of a section or a first part of a paragraph appearing in a page of a document by analyzing the layout of a page of the translation, and moves the parts subsequent to the first part of the section or the first part of the paragraph to the next page of the translation, so as to make a space to insert the advertisement. Alternatively, CPU may change the layout of the translation to make a space to insert the advertisement, for example by narrowing character spacing or line spacing, or making sizes of type faces smaller.

Advertisement insertion unit 105 generates an output image by inserting the advertisement at the insertion location determined by advertisement location determining unit 104.

Output unit 107 outputs the output image generated by advertisement insertion unit 105. More specifically, output unit 107 causes image forming unit 6 to form the output image on the surface of sheet.

A-3. Operations

In the description of the present embodiment below, an example is given of a case where a Chinese document is translated to Japanese or English. It is also assumed that the Chinese document describes a car exhibited at a motor show held in China.

FIG. 2 illustrates an overview of operational flow in translation device 1. In FIG. 2, it is assumed that translation device 1 has already been powered on and CPU is running computer programs.

A user puts paper document (it will be referred to hereinafter simply as document) face down on platen glass 2. When a start button is pressed at instruction input unit 41, image input unit 12 generates image data of the document and stores the image data in storage unit 5.

When a user specifies Japanese as a target language for translation at instruction input unit 41, CPU sets the target language as Japanese (in step A01).

In step A02, CPU selects advertisement data by using advertisement data selection unit 103. In the present embodiment, advertisement data written in Japanese, advertising a car, is selected.

In step A03, CPU determines an insertion location of an advertisement in an output image by using insertion location determining unit 104.

In step A04, CPU generates an output image by inserting the advertisement at the insertion location determined.

FIG. 3 illustrates details of operations of translation device 1 in selecting advertisement data.

In step B01, CPU sets the target language as Japanese, as specified by a user at target language specifying unit 101. CPU translates a document to Japanese by using translation unit 106.

In step B02, CPU determines whether the condition data for selecting advertisement data includes a condition relating to contents of a document. In the present embodiment, it is assumed that the condition data includes a condition relating to contents of a document.

In step B03, CPU extracts a keyword(s) from the Japanese translation of the document. For example, if a Japanese term ‘ [symbol] (car)’ appears repeatedly in the document, CPU extracts the term ‘ [symbol] (car)’ as a keyword of the document.

In step B04, CPU inquires of advertisement data storage unit 102 as to whether advertisement data written in Japanese and relating to the term ‘car’ is available.

CPU selects the advertisement data written in Japanese advertising a car, which is received from advertisement data storage unit 102, when advertisement data relating to the term ‘car’ is available.

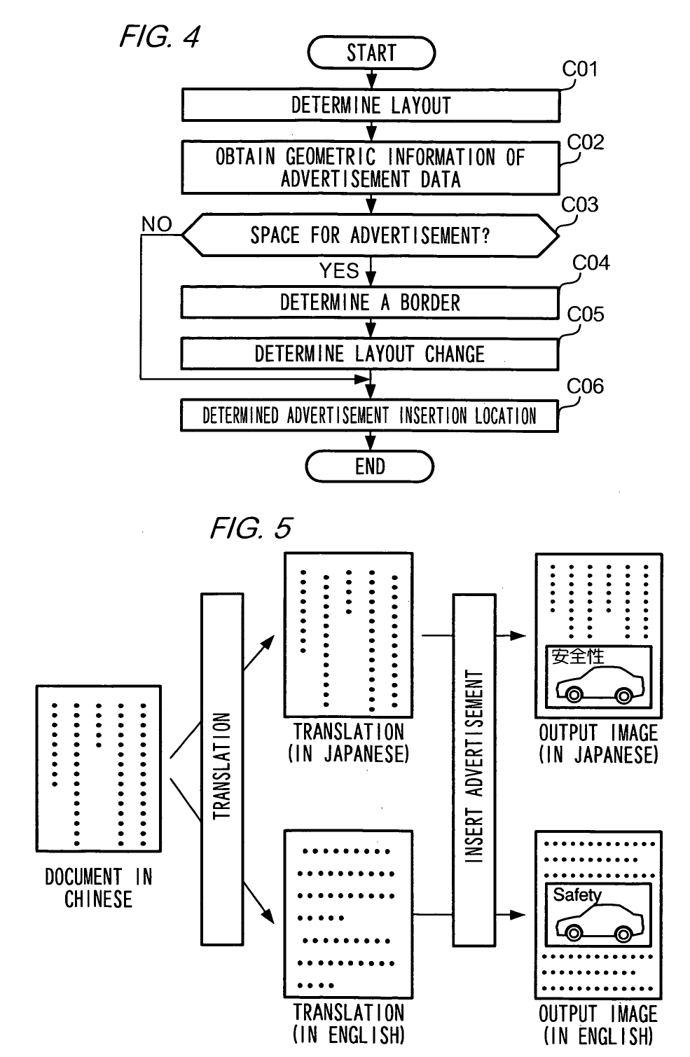

FIG. 4 illustrates details of operations of translation device I in determining an insertion location of an advertisement. FIG. 5 illustrates two examples of data flow at translation device 1 to output either a Japanese or an English document.

In the first example (in an upper flow in FIG. 5), an insertion location of an advertisement is determined in the Japanese translation.

In step C01, CPU determines a layout of a translation of a document. In the present example, CPU determines a vertically written layout of the Japanese translation of the Chinese document.

In step C02, CPU obtains geometric information included in the selected advertisement data, such as a size and a shape of the advertisement to be printed.

In step C03, CPU determines whether there is a space to insert the advertisement in the output image of the translation of the document. If there is not enough room to insert the advertisement, CPU advances its operation to step C04, otherwise CPU moves to step C06.

In step C04, CPU determines a border(s) of sections, a border(s) of paragraphs, or the like in the translation of the document. In the present example, there appears on a page a vertical border between two paragraphs in the Japanese translation.

In step C05, CPU determines changes to be applied to an layout of the translation to be output with the advertisement. In the present example, CPU determines to reduce the printing area of the translation, when there is not enough room between the current vertical border and the right margin of the page.

In step C06, CPU changes character spacing, and line spacing of the translation, so as to reduce the printing area of the translation and to make a space to insert the advertisement in the same page. CPU puts the translation at the upper portion of the page and determines the advertisement insertion location to be at the lower portion of the page.

In the second example (in a lower flow in FIG. 5), an insertion location of an advertisement in the English translation is determined.

In the present example, there appears on a page a horizontal border between two paragraphs in the English translation (in step C04). CPU determines to make a space to insert the advertisement in the center of the page between the two paragraphs and to reduce the printing areas of the two paragraphs of the translation (in steps C05 and C06).

Accordingly, an advertisement written in a target language may be inserted in a translation of a document in the target language. Thus, the advertisement has relevance for a user who reads the translated document.

### B. Second Embodiment

B-1. Configuration

Translation device 1 according to the second embodiment has an identical hardware configuration to that of the first embodiment.

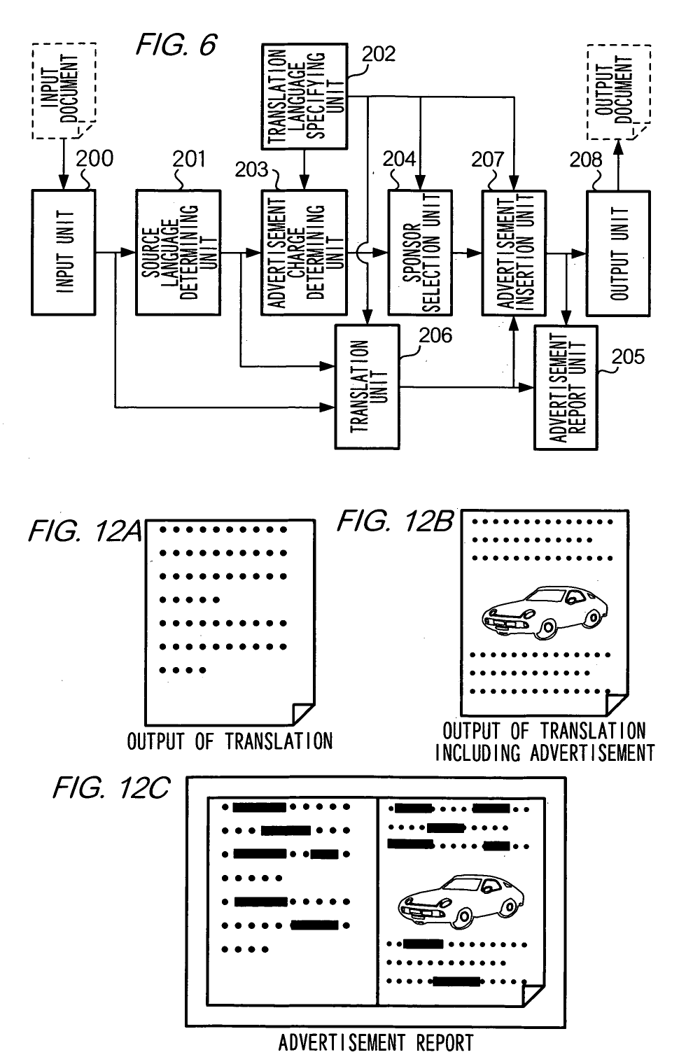

FIG. 6 illustrates a functional block diagram of translation device 1 according to the present embodiment. CPU executes programs stored in storage unit 5 to perform these functions.

Input unit 200 inputs a document by using image input unit 12, and generates image data of the document.

Storage unit 5 stores a known OCR (Optical Character Recognition) program. CPU executes the OCR program and performs character recognition. Image input unit 12 may be a separate scanning device connected to translation device 1 via a network.

Source language determining unit 201 determines a language of a document from the image data generated by input unit 200. More specifically, source language determining unit 201 determines a source language of a document to be translated (hereinafter referred to as a source language) by matching terms included in the document and words stored in dictionary 51.

A target language is specified by target language specifying unit 202. More specifically, a menu listing names of various target languages is displayed at display unit 39. A target language is specified by a user using a touch panel function provided in displaying unit 39.

An advertisement charge table is stored in storage unit 5, and includes a set of a source language, a target language, and an advertisement charge determined on the basis of a combination of the source language and the target language.

FIG. 9 illustrates an example of an advertisement charge table. In the present example, the FIGS. ‘1’, ‘2’, and ‘3’ denote the difficulty of translation. For example, a translation from Korean to Japanese is set to ‘1’ as easiest; and a translation from Chinese to Korean is set to ‘3’ as most difficult.

As the difficulty of translating from one language to another increases, either it takes more time for a CPU to perform the translation, or it is necessary to use a complex computer program which has taken more time to prepare. Accordingly, a higher translation charge should be incurred for a more difficult translation from one language to another language.

Thus, it is reasonable to charge a sponsor a higher advertisement charge in accordance with the difficulty of translation, so as to bear more of the translation charge and reduce the translation charge payable by the user.

Alternatively, an advertisement charge may be set in accordance with the demand for translation from one language to another language. The advertisement charge may be lower when translations are frequently performed for the same source language/target language pair.

Furthermore, storage unit 5 may include a set of a source language, a target language, and a flag indicating whether a translation is executable from the source language to the target language. If the flag of ‘not-executable’ is set from the source language to the target language, then a message is displayed at display unit 39 to indicate that no translation can be performed.

Advertisement charge determining unit 203 determines an advertisement charge on the basis of advertisement charge table for a combination of the source language determined by source language determining unit 201 and the target language specified by target language specifying unit 202.

An upper limit table (not shown) is stored in storage unit 5, and includes a set of a sponsor and the upper limit of an advertisement charge which the sponsor should pay.

A co-sponsoring allowance table is also stored in storage unit 5, and includes a set of a sponsor and their position on co-sponsoring.

Sponsor selection unit 204 extracts one or more sponsors on the basis of the upper limit table from among sponsors who it is determined will be prepared to pay the advertisement charge determined by the advertisement charge determining unit 203, and selects a sponsor from the one or more extracted sponsors in accordance with a prescribed rule. For example, a sponsor may be randomly selected from the multiple extracted sponsors. Alternatively, a sponsor may be selected in turn for each translation performed at translation device 1 in alphabetical order according to their name.

If there is no sponsor who it is determined will be prepared to pay the advertisement charge determined by advertisement charge determining unit 203, sponsor selection unit 204 selects multiple sponsors on the basis of the upper limit table and the co-sponsoring allowance table. In such a case the advertisement charge determined by advertisement charge determining unit 203 is covered by the multiple sponsors, so that the advertisement charge covered by each sponsor may be reduced.

Sponsor selection unit 204 selects advertisement data of the selected sponsor from advertisement data storage unit.

Translation unit 206 generates from the image data of a document generated by input unit 200, a translation of the document written in the target language specified by target language specifying unit 202. For example, a known morphological analysis approach, a known syntax analysis approach, and a known semantic analysis approach may be applied to generate a translation of a document by analyzing syntaxes of the document to generate syntax trees of the document, converting the syntax trees to a target language, selecting a translation of each morpheme from dictionary 51, and replacing each morpheme with its translation in the converted syntax trees.

Advertisement insertion unit 207 determines an insertion location for inserting the advertisement in a similar manner to advertisement location determining unit 104 in the first embodiment, and generates an output image by inserting the advertisement at the insertion location determined.

Advertisement report unit 205 outputs a report on the insertion of an advertisement, when the advertisement is inserted in the output image of a translation by advertisement insertion unit 207. The report is used to confirm to a sponsor that an advertisement of the sponsor is inserted in the output image of the translation.

The report output by advertisement insertion unit 207 may be constituted from the output image of a translation including the advertisement, as illustrated in FIG. 12B. Alternatively, the report may be shown side-by-side with an output image of a translation without an advertisement and an output image of the translation including the advertisement, as shown in FIG. 12C. In a further example, a report is constituted from a message that a generated output image includes the advertisement.

The report may be stored in storage unit 5 or in an external storage device. Alternatively, the report may be transmitted to a computer device owned by a sponsor of the advertisement via a network, whenever an output image of a translation including the sponsor's advertisement is outputted.

In the present embodiment, when some terms in a translation generated by translation unit 206 are determined to match prescribed rules, these terms may be masked in the advertisement report output by advertisement report unit 205. For example, such terms may be painted over with black ink.

For example, when medical information such as a name of a disease together with the name of a patient is included in a translation, such terms are masked in the report so as to protect private information. In another example, when significant statistics are included in a translation, such figures are masked in the report so as to preserve confidential information relating to a corporation.

Output unit 208 outputs the output image generated by advertisement insertion unit 207. More specifically, output unit 208 causes image forming unit 6 to form the output image on the surface of a sheet.

B-2. Operations

In the description of the present embodiment below, an example is given with respect to a case where a Chinese document is translated to Japanese or English. It is also assumed that the Chinese document describes a car exhibited at a motor show held in China.

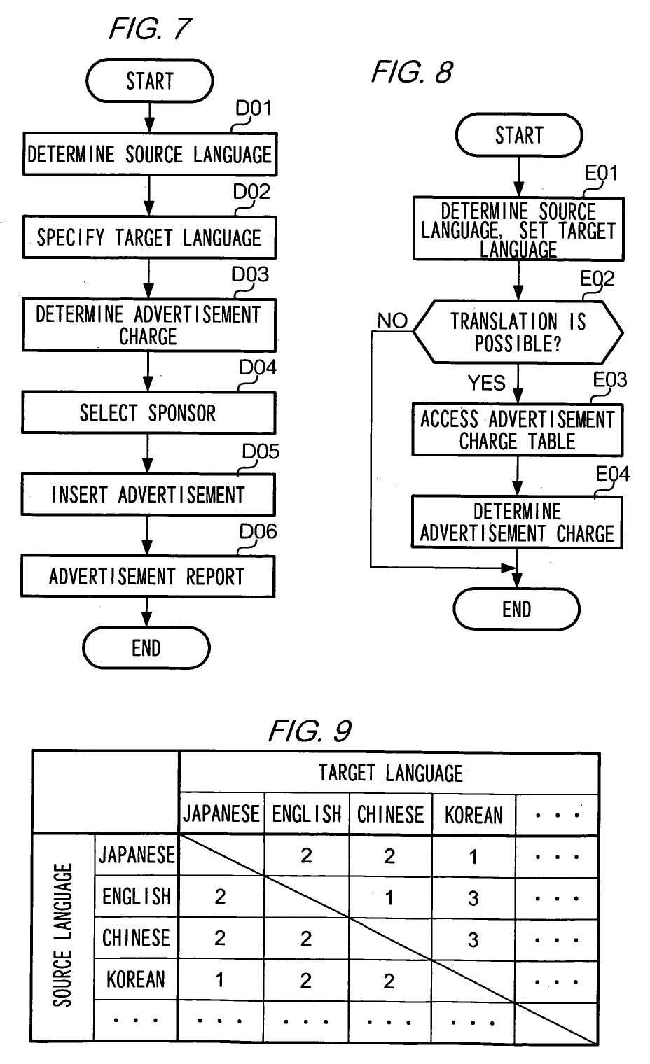

FIG. 7 illustrates an overview of an operational flow in translation device 1 according to the present embodiment. In FIG. 7, it is assumed that translation device 1 has already been powered on and CPU is running computer programs.

A document is put by a user face down on platen glass 2. When a start button is pressed at instruction input unit 41, image input unit 12 generates image data of the document and stores the image data in storage unit 5.

A target language is specified as Japanese by a user at instruction input unit 41.

In step D01, CPU determines a source language used in a document by using language determining unit 201.

In step D02, CPU sets the target language as Japanese, as specified is by a user at target language specifying unit 202.

In step D03, CPU determines an advertisement charge by using advertisement charge determining unit 203. In the present embodiment, CPU determines the advertisement charge for a Chinese to Japanese translation on the basis of the advertisement charge table shown in FIG. 9.

In step D04, CPU determines a sponsor of the advertisement to be inserted in the output image by using sponsor selection unit 204.

In step D05, CPU generates an output image of the translation by inserting the advertisement using advertisement insertion unit 207.

In step D06, CPU outputs information that an advertisement is inserted in the output image of the translation by using advertisement report unit 205.

FIG. 8 illustrates details of operations of translation device 1 in determining an advertisement charge.

In step E01, CPU determines the source language of a document, and sets the target language.

In step E02, CPU determines whether a translation from the source language to the target language is possible in translation device 1, on the basis of the flag stored in storage unit 5 for the combination of the source language and the target language.

If the translation from the source language to the target language is possible (in step E02:Yes), CPU accesses the advertisement charge table (in step E03), and determines an advertisement charge for the translation on the basis of the table by using advertisement charge determining unit 203 (in step E04). In the present embodiment, the advertisement charge for a translation from Chinese to Japanese is determined by the difficulty of ‘2’ as shown in the advertisement charge table of FIG. 9.

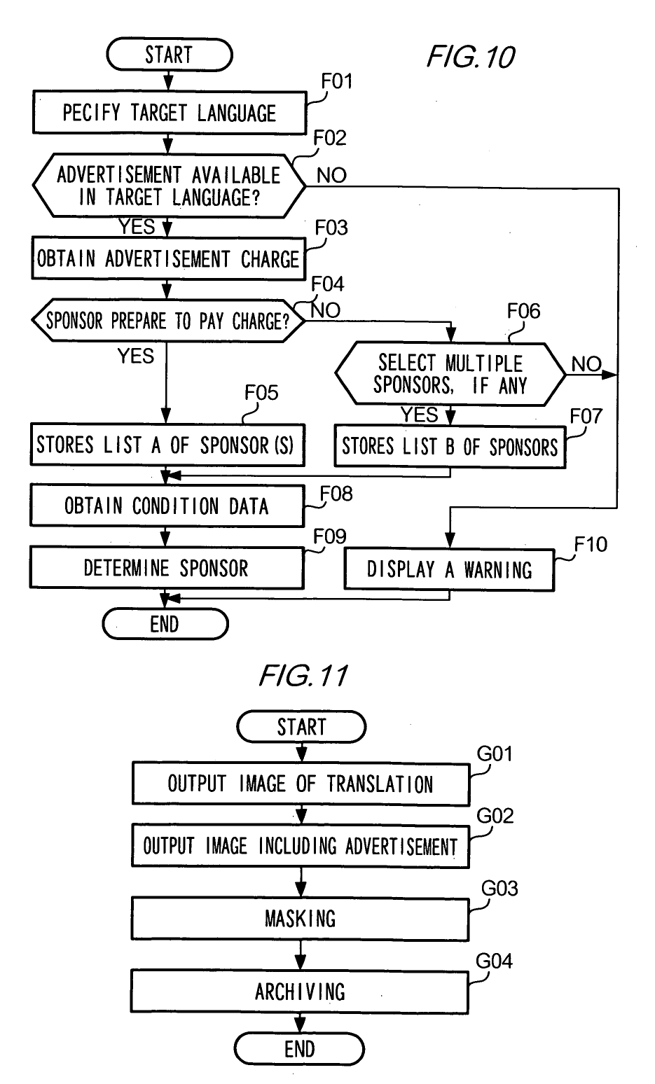

FIG. 10 illustrates details of operations of translation device 1 in selecting a sponsor of an advertisement.

In step F01, CPU sets the target language

In step F02, CPU inquires advertisement data storage unit 102 if there is advertisement data written in the target language.

If there is advertisement data (in step F02:Yes), CPU advances its operation to step F03, otherwise CPU branches its operation to step F10.

In step F03, CPU obtains the advertisement charge determined by advertisement charge determining unit 203.

In step F04, CPU extracts one or more sponsors who are prepared to pay the determined advertisement charge from the upper limit table.

If there is a sponsor (in step F04:Yes), CPU advances its operation to step F05, otherwise CPU branches its operation to step F06.

In step F05, CPU stores a list A of the one or more extracted sponsors in storage unit 5.

In step F06, CPU selects multiple sponsors from the co-sponsoring allowance table, if any.

In step F07, CPU stores a list B of the selected multiple sponsors in storage unit 5.

In step F08, CPU obtains condition data, such as information on the location of translation device 1, or information on the time of day when translation is performed at translation device 1.

In step F09, CPU selects one or more sponsors, which match the condition data obtained in step F08 from the sponsors listed either in the list A or in the list B.

In step F10, CPU displays a warning message at display unit 39 stating that no discount of translation charge is available since no advertisement is provided to the document to be translated.

FIG. 11 illustrates details of operations of translation device 1 in outputting an advertisement report.

In step G01, CPU generates image data of a translation translated is by translation unit 206, as shown in FIG. 12A.

In step G02, CPU generates image data of the translation including the advertisement generated by using advertisement insertion unit 207, as shown in FIG. 12B.

In step G03, CPU detects terms in the translation generated by translation unit 206, which match prescribed conditions, and masks the detected terms. FIG. 12C illustrates an example of an output image of a translation in which some terms are masked.

In step G04, CPU stores in storage unit 5 for archiving purposes a set of a masked image of a translation of the document without advertisement and a masked output image of the translation including the advertisement.

Accordingly, an advertisement charge is determined for inserting advertisement in a translation of a document; a sponsor(s) of the advertisement is determined; and an output image of the translation including the advertisement is provided to a user. A financial burden of a user may be reduced, since a total or a part of the translation charge is covered by the advertisement charge.

C. Modifications

(1) Image input unit 12 may be a separate scanning device connected to translation device 1 via a network. Image forming unit 6 may be a separate printing device connected to translation device 1 via a network.

Advertisement data storage unit 102 may be a separate scanning device connected to translation device 1 via a network, or may be included in translation device 1.

Output units 107 and 208 may transmit data of the output image to an external computer device or an external display device via a network.

Alternatively, output units 107 and 208 may store data of the output image in a storage medium, such as a magnetic disk.

(2) The condition data, stored in advertisement data storage unit 102, may include a location of translation device 1. For example, when translation device 1 is installed in a showroom of audio equipment, it is suitable to print an advertisement of a manufacturer of audio equipment, since the visitor to the showroom is probably interested in audio equipment.

The condition data may include a time of day, when translation device 1 is used to translate. For example, in the morning, it is suitable to print a lunch menu of a cafeteria as an advertisement, whereas in the afternoon, it is suitable to print an advertisement of a hotel.

As is described above, the present invention provides a translation device including: an input unit that inputs a document; a specifying unit that specifies a target language; a translation unit that translates the inputted document into the translated document written in the target language specified by the specifying unit; a memory that stores a set of condition data and advertisement data assigned to the condition data, or a set of a keyword and advertisement data assigned to the keyword; a data selection unit that selects advertisement data from the memory, the advertisement data being assigned either to condition data or a keyword; a location determining unit that determines an insertion location at which to insert the advertisement data selected by the data selection unit into the translated document, by taking into account a layout of the translated document; a image generating unit that generates an output image of the translated document by inserting the advertisement data at the insertion location determined by the location determining unit; and an outputting unit that outputs the output image generated by the image generating unit.

The present invention provides a translation method including: inputting a document; specifying a target language; translating the inputted document into the translated document written in the target language specified; selecting advertisement data from a memory on the basis of condition data or a keyword, the memory storing a set of condition data and advertisement data assigned to the condition data or a set of a keyword and advertisement data assigned to the keyword; determining an insertion location at which to insert the advertisement data selected into the translated document, by taking into account a layout of the translated document; generating an output image of the translated document by inserting the advertisement data at the insertion location determined; and outputting the output image generated.

The present invention further provides a storage medium readable by a computer, the storage medium storing a program of instructions executable by the computer to perform a function, the function including:

inputting a document; specifying a target language; translating the inputted document into the translated document written in the target language specified; selecting advertisement data from a memory on the basis of condition data or a keyword, the memory storing a set of condition data and advertisement data assigned to the condition data or a set of a keyword and advertisement data assigned to the keyword; determining an insertion location at which to insert the advertisement data selected into the translated document, by taking into account a layout of the translated document; generating an output image of the translated document by inserting the advertisement data at the insertion location determined; and outputting the output image generated.

Accordingly, an advertisement written in a target language may be inserted in a translation of a document in the target language, wherein the advertisement is selected on the basis of condition data including a condition of translating or a condition relating to contents of a document.

Thus, the advertisement has relevance for a user who reads the translated document.

The foregoing description of the embodiments and modifications of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-90233 filed on Mar. 25, 2005, including specification, claims, drawings, and abstract is incorporated by reference.

What is claimed is:

1. A translating device, comprising:
an input unit that inputs a document;
a specifying unit that specifies a target language;
a translation unit that translates the inputted document into the translated document written in the target language specified by the specifying unit;
a memory that stores a set of condition data and advertisement data assigned to the condition data, or a set of a keyword and advertisement data assigned to the keyword;
a data selection unit that selects advertisement data from the memory, the advertisement data being assigned either to condition data or a keyword;
a location determining unit that determines an insertion location at which to insert the advertisement data selected by the data selection unit into the translated document, by taking into account a layout of the translated document;
a image generating unit that generates an output image of the translated document by inserting the advertisement data at the insertion location determined by the location determining unit; and
an outputting unit that outputs the output image generated by the image generating unit.

2. The device according to claim 1, wherein
the condition data includes a condition relating to a target language.

3. The device according to claim 1, wherein
the location determining unit determines changes in an output layout of the translated document, when there is not enough space at which to insert the advertisement data.

4. The device according to claim 1, further comprising:
an advertisement charge table that stores a set of a source language of the inputted document, a target language, and advertisement charge specified on the basis of a combination of the source language and the target language;
a charge determining unit that determines an advertisement charge on the basis of the advertisement charge table for the combination of the source language and the target language;
an upper limit table that stores a set of a sponsor and upper limit of an advertisement charge which the sponsor is prepared to pay; and
a sponsor selection unit that selects a sponsor from one or more sponsors who are prepared to pay the advertisement charge on the basis of the upper limit table,
wherein the data selection unit selects advertisement data of the sponsor selected by the sponsor selection unit from the memory.

5. The device according to claim 4, further comprising
a co-sponsoring allowance table that stores a set of a sponsor and their position on co-sponsoring,
wherein the sponsor selection unit selects a plurality of sponsors on the basis of the upper limit table and the co-sponsoring allowance table, if there is no sponsor who is prepared to pay the advertisement charge determined by the charge determiningunit.

6. The device according to claim 1, further comprising:
a report outputting unit that outputs a report that the advertisement data is inserted into the output image of the translation.

7. The device according to claim 6, further comprising
a masking unit that masks a term matching prescribed conditions in the translated document.

8. A translation method for translating, comprising:
inputting a document;
specifying a target language;
translating the inputted document into the translated document written in the target language specified;
selecting advertisement data from a memory on the basis of condition data or a keyword, the memory storing a set of condition data and advertisement data assigned to the condition data or a set of a keyword and advertisement data assigned to the keyword;
determining an insertion location at which to insert the advertisement data selected into the translated document, by taking into account a layout of the translated document;
generating an output image of the translated document by inserting the advertisement data at the insertion location determined; and
outputting the output image generated.

9. The translation method according to claim 8, wherein
the condition data includes a condition relating to a target language.

10. The translation method according to claim 8, further comprising:
changing the layout of the translated document when there is not enough space at which to insert the advertisement data.

11. The translation method according to claim 8, further comprising:
determining an advertisement charge for a combination of a source language of the document and the target language on the basis of an advertisement charge table, the advertisement charge table storing a set of a source language, a target language, and advertisement charge specified to a combination of the source language and the target language;
selecting a sponsor from one or more sponsors who are prepared to pay the advertisement charge on the basis of an upper limit table, the upper limit table storing a set of a sponsor and upper limit of an advertisement charge which the sponsor is prepared to pay; and
selecting, from the memory, advertisement data of the sponsor selected.

12. The translation method according to claim 11, further comprising:
selecting a plurality of sponsors on the basis of the upper limit table and a co-sponsoring allowance table, when no sponsor is selected who is prepared to pay the advertisement charge determined, the co-sponsoring allowance table storing a set of a sponsor and their position on co-sponsoring.

13. The translation method according to claim 8, further comprising:
outputting a report that the advertisement data is inserted into the output image of the translation.

14. The translation method according to claim 13, further comprising:
masking a term matching prescribed conditions in the translated document.

15. A storage medium readable by a computer, the storage medium storing a program of instructions executable by the computer to perform a function, the function comprising:
inputting a document;
specifying a target language;
translating the inputted document into the translated document written in the target language specified;
selecting advertisement data from a memory on the basis of condition data or a keyword, the memory storing a set of condition data and advertisement data assigned to the condition data or a set of a keyword and advertisement data assigned to the keyword;
determining an insertion location at which to insert the advertisement data selected into the translated document, by taking into account a layout of the translated document;
generating an output image of the translated document by inserting the advertisement data at the insertion location determined; and
outputting the output image generated.

16. The storage medium according to claim 15, wherein
the condition data includes a condition relating to a target language.

17. The storage medium according to claim 15, further comprising:
changing the layout of the translated document when there is not enough space at which to insert the advertisement data.

18. The storage medium according to claim 15, further comprising:
determining an advertisement charge for a combination of a source language of the document and the target language on the basis of an advertisement charge table, the advertisement charge table storing a set of a source language, a target language, and advertisement charge specified to a combination of the source language and the target language;
selecting a sponsor from one or more sponsors who are prepared to pay the advertisement charge on the basis of an upper limit table, the upper limit table storing a set of a sponsor and upper limit of an advertisement charge which the sponsor is prepared to pay; and
selecting, from the memory, advertisement data of the sponsor selected.

19. The storage medium according to claim 18, further comprising:
selecting a plurality of sponsors on the basis of the upper limit table and a co-sponsoring allowance table, when no sponsor is selected who is prepared to pay the advertisement charge determined, the co-sponsoring allowance table storing a set of a sponsor and their position on co-sponsoring.

20. The storage medium according to claim 15, further comprising:
outputting a report that the advertisement data is inserted into the output image of the translation.

21. The storage medium according to claim 20, further comprising:
masking a term matching prescribed conditions in the translated document.
